(19) United States
(12) Patent Application Publication
(10) Pub. No.: US 2008/0037748 A1
(43) Pub. Date: Feb. 14, 2008

(54) Method of and System for Conference Calling

(75) Inventors: Todd Jefferson, Manotick (CA); Yanick Dufresne, Ottawa (CA); Andrew Hackston, Ottawa (CA); Noam David Tomczak, Ottawa (CA); Alec Saunders, Manotick (CA); Howard H. Thaw, Green Valley (CA)

Correspondence Address: BUCKINGHAM, DOOLITTLE & BURROUGHS, LLP, 3800 EMBASSY PARKWAY, SUITE 300, AKRON, OH, 44333-8332, US

(73) Assignee: Iotum Corporation, a Delaware corporation, Ottawa (CA)

(21) Appl. No.: 11/457,258

(22) Filed: Jul. 13, 2006

(51) Int. Cl. H04M 3/42

(52) U.S. Cl. 379/202.01

(57) ABSTRACT

The present invention relates generally to the field of telecommunications and more particularly to a method of and system for setting up and initiating conference communications One aspect of the invention is broadly defined as a method of conference communication management comprising the steps of scheduling a conference communication with a number of participants, using a telephone number of an originator of the conference communication as the dial in number (or some other unique resource identifier); responding to arrival of a call on the telephone number of the originator of the conference communication by: determining whether the calling party should be allowed to join the conference communication; and responding to the calling party being allowed to join the conference communication by connecting the calling party to the conference communication bridge; otherwise, routing the call on the telephone number of the originator, elsewhere.

### FIELD OF INVENTION

The present invention relates generally to the field of telecommunications and more particularly to a method of and system for setting up and initiating conference communications.

### BACKGROUND OF THE INVENTION

In today's business world any tool that can improve employee productivity and efficiency is of great value Conference communications, for example, allow users in three or more locations to hold two-way simultaneous communications, allowing users to avoid the cost and time of traveling, allowing parties spread over broad geographic areas to collaborate easily, and avoiding the inconvenience of two-party-only communications. Conference communications can be held through voice, video, text, or combinations of these media.

Telephone conference calling (or teleconferencing) is made possible through the public switching telephone network (PSTN) using phone switches or advanced telephones, mixing media, and delivering the mixed media to all participating telephones Teleconferencing, Video Conferencing and Text-based conferencing are made possible through the Internet by special software running on network nodes that mix the media and deliver it to all the participating end points.

Though widely used, existing conference communication systems still have some very inconvenient limitations. In particular, the process for setting up a conference call is time consuming and can be frustrating. As well, the process for initiating and running a conference call is also cumbersome and error-prone.

The typical process for setting up a conference call is very inefficient. First, the organizer must reserve a conference bridge, and have a pin number and/or conference call number assigned by the conference provider. The organizer of the conference call then has to communicate the conference bridge number, the pin code to access the conference call and/or the conference number, to all of the participants and determine whether they are available. The organizer then waits for the participants to advise on their availability, and if the organizer decides to proceed, he confirms the reservation of the conference bridge, and confirms back to all of the participants that the conference call will proceed.

This process can take 10-15 minutes (not including time waiting for responses to invitations) and can cause great frustration. For example, if the call organizer makes a mistake when communicating the conference information to the participants, then the participants will not be able to access the conference call. As well, if the organizer decides that too many individuals are unavailable at the proposed time, the organizer will advise participants of the cancellation and then start again, reserving a new conference bridge, inviting participants to the newly proposed venue and waiting for confirmation The organizer has no idea whether his second proposal will have any better chance of success than his first attempt.

When the conference call is scheduled to begin, participants have to call the conference bridge phone number and enter the pin code and/or conference number to join the conference call. If a participant does not have all of the required information or enters it incorrectly, he will not be able to join the conference call. This will either delay the start of the conference call or keep it from going forward altogether (i.e. if a critical participant is unable to access the conference). Participants that have successfully entered the conference bridge will typically have to wait until all the participants have joined the conference or the decision is made to abandon the conference call because certain parties have not managed to join. Even when all participants successfully join the conference call the entire setup procedure can easily take 5-10 minutes.

As well, the first caller to join a conference call generally sits in an empty conference call until the organizer or another participant joins in. This can be awkward, particularly in business situations.

Recently, conference communication providers have been developing systems that attempt to case the difficulty of organizing and initiating conference communications, but these systems fall short of what is required. For example, there are systems that allow users to schedule conference calls and automate the sending of email notifications to participants with information regarding a conference call, such as the bridge phone number and pin code, but these systems typically force the user to schedule the conference call on the service provider's website.

With these systems conference call participants still have to call a special conference bridge phone number. They also have to enter a pin number and/or conference call number to identify themselves as participants. While these systems somewhat ease the difficulties offsetting up a conference call they do not improve the process for initiating the conference call at all. With systems such as these, setting up and initiating conference calls can still take between 10-15 minutes. Of course, if a participant enters any of the conference data incorrectly or loses any of it, then he still cannot participate in the call.

There is therefore a need for a method of and system for setting up and initiating conference communications which addresses the problems outlined above. This system and method should be user-friendly, compatible with existing communication infrastructure and cost effective.

### SUMMARY OF THE INVENTION

The present invention relates to a method of and system for setting up and initiating conference communications. It is an object of the invention to provide an improved method of and system for setting up and initiating conference communications which obviates or mitigates at least one of the disadvantages described above

The conference solution of the invention greatly increases the efficiency, reliability and accessibility of conference communications. The concepts of the invention can be applied to any conference communication application, by businesses and consumers.

With the system and method of the invention, conference communication participants do not have to dial a separate telephone number to access a conference communication, they simply call the organizer's normal telephone number. Participants do not have to enter a pin code because a “relevance engine” on the system distinguishes conference communication participants from other callers. Participants are automatically joined into the conference, while non-participants are routed to voicemail, an interactive voice response (IVR) system, the organizer's assistant, or elsewhere.

The organizer of the conference communication is also automatically joined into the conference when the first participant calls the organizer's telephone number, avoiding the problem of a participant having to wait in an empty conference bridge for another participant or the organizer to join.

With the system of the invention, every telephone number on the local communication system has a conference bridge attached. When a conference communication is created by the organizer in his personal information manager:
the participants are emailed a request to attend; and
the system stores the participant information, time and date information in its database.

When the conference is scheduled to happen, the participants simply call the conference organizer's normal telephone number. When a call is made to the organizer's telephone number at a time when a conference call is scheduled, the system determines whether the calling party is on the conference participant list. If the calling party is on the list, the system connects them to the conference bridge. If the calling party is not a participant in the conference call they are routed elsewhere, for example, to the conference originators voicemail, or to a delegate.

If a participant loses the organizer's telephone number, it will often be easy to obtain from a receptionist, directory assistance or other source. Thus, the participant can still join the conference without much difficulty. However, as note in the Background above, a participant will not be able to join a traditional conference call until they find all of the necessary data such the conference telephone number, conference number and PIN code. This information can be very difficult to find at the last minute.

The system of the invention makes it easy to set up and manage conference communications. It requires no knowledge of conference bridges, access codes, or other esoterica of setting up a conference call. It simply requires that the conference originator enter a conference call meeting into his personal information manager. The system takes care of all of the rest of the details.

The system of the invention cuts the time required to set up a conference call from 10-15 minutes, down to less than one minute. In addition, it simplifies the management of the conference call by not requiring PIN numbers or special conference bridge numbers. Thus, participants have much less difficulty accessing the conference communication, and the likelihood that they can successfully access the conference, rises dramatically.

The system of the invention is also operable to designate participants as “optional” or “required”. Entry of the first participant into the conference causes the system to call all of the remaining required participants. Optional participants will be added to the conference as they call the user's normal telephone number, but the system will not attempt to contact those optional participants. Other classes of callers could also be defined and accommodated.

The method and system described herein can be applied to all multimedia conferencing networks and is compatible with existing communication infrastructure. These can include the public switching telephone network and the Internet, but could include any data network capable of multimedia communication.

This design simplifies the setup and initiation of conference calling using a conference bridge, but it should be clear that the design is not a conference bridge itself. The design integrates with an existing conference bridge.

One aspect of the invention is broadly defined as a method of conference communication management comprising the steps of scheduling a conference communication with a number of participants, using a unique resource identifier of an originator of the conference communication as the dial in number; responding to arrival of a call on the telephone number of the originator of the conference communication by: determining whether the calling party should be allowed to join the conference communication; and responding to the calling party being allowed to join the conference communication by connecting the calling party to the conference communication bridge; otherwise, routing the call on the telephone number of the originator, elsewhere.

Another aspect of the invention is broadly defined as a conference communication management system comprising: an originator communication device; two or more participant communication devices; a telephone switch including a conference bridge; a relevance server; a communication network inter connecting the originator communication device, the two or more participant communication devices, the telephone switch and the relevance server; the relevance server being operable to: respond to arrival of a call on the unique resource identifier of the originator communication device, during a scheduled conference communication, by: determining whether the calling party should be allowed to join the conference communication; and responding to the calling party being allowed to join the conference communication by connecting the calling party to the conference communication bridge; otherwise, routing the call on the unique resource identifier of the originator, elsewhere.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 presents a flow chart of a method of setting up a conference communication in an embodiment of the invention;

FIG. 2 presents a flow chart of a method of initiating a conference communication in an embodiment of the invention; and

FIG. 3 presents a block diagram of a conference communication system in an embodiment of the invention.

### DETAILED DESCRIPTION OF THE INVENTION

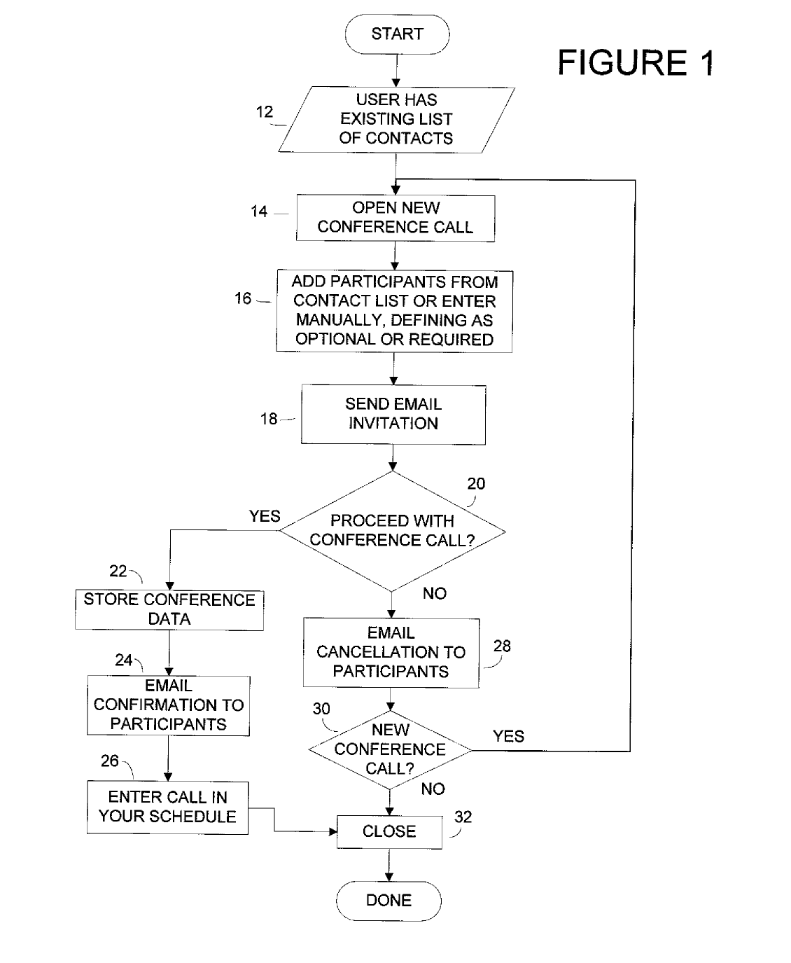

An exemplary method of setting up a conference communication is presented in the flow chart of FIG. 1. The bulk of the description is framed in terms of a telephone conference call being set up using a telephony system, but of course, could be applied to any manner of media, such as voice, text, video or combinations of these As well, the conference communication could be set up over any communication network, and is not limited to the ones described herein.

The system is preferably linked to a personal information manager (PIM) server supporting software such as Microsoft Outlook™, Groupwise™, or a similar application. The organizer of the conference call will typically have an existing list of contacts or addresses that they have been compiling over time 12. To open a new conference communication 14 the organizer simply clicks on a new menu option in his PIM software which opens a conference call window in the same manner that a new meeting or new appointment window would be opened. Alternatively, the system could simply generate a new appointment which can be defined as a conference communication (i.e. simply adding a new box to click, in the appointment setup window). The specifics of how this would be done depends on the particular PIM application being used.

From this “new conference” window, the organizer can specify the title or purpose of the conference communication, the time and date, identify his unique resource identifier (which is the conference call number), and any other particulars that he wishes to communicate to the participants. Note that the unique resource identifier maybe a telephone number, email address, URL, or similar address (these may also change over time as technology evolves).

The system can also retrieve contact and calendar information from personal information management servers such as Outlook Exchange™. For example, the organizer can populate the list of participants for the meeting 16 by dragging them from his contact list, or double-clicking on them. The organizer can also manually enter new participants into this list, though that would require both the new participant's email address and telephone number (or numbers) that they would be expected to call from. As well, the organizer will be able to access the personal schedules of certain participants so he can propose a time at which participants are available. If the first attempt to set up a conference fails, then the originator is in a far better position to make a second attempt than he would be with the prior art system.

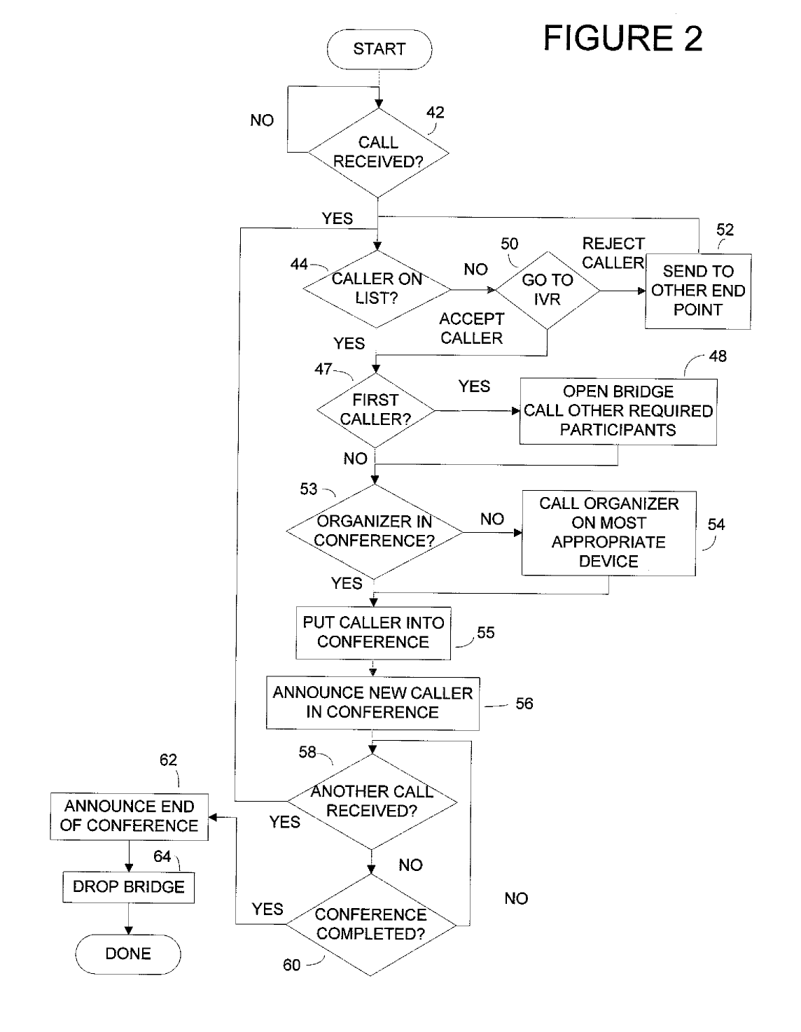

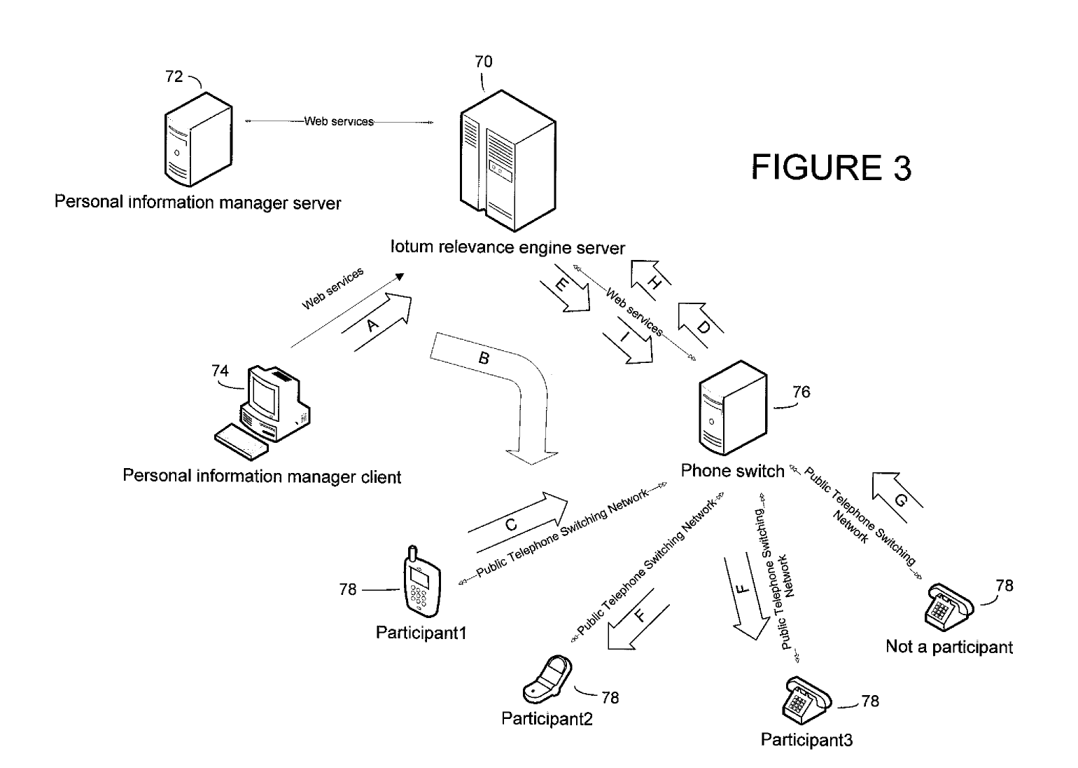

The organizer is also able to specify whether participants are to be considered “required” or “optional” as part of step 16. As shown in FIGS. 2 and 3, the system will automatically endeavour to seek out the “required” participants once the communication has commenced, and will not seek out the “optional” participants. Of course, if the “optional” participants attempt to join the conference, they will be allowed to do so.

It is preferable that the system of the invention dynamically assign a conference bridge to any telephone number on the local system, on demand. The conference server (possibly on a PBX, IP PBX, or similar system) has a pool of common conference rooms that can be assigned to a given phone number when the relevance engine server specifies that it is required. It is safe to assume that not every telephone number on the local system is going to require a conference room at the same time, thus the size of the pool of conference rooms does not need to be the same as the number of telephone numbers that exist in the system. The size of the conference room pool should be chosen to minimize the use of resources while at the same time ensuring that the probability of running out of conference rooms is sufficiently low, and will depend, of course, on the nature of the business environment. Resource management of this kind is well known in the field of telephony systems.

Once the particulars of the proposed conference communication are established, the participants are then emailed an invitation to attend at step 18. The organizer waits for responses from the participants and decides whether to proceed with the call 20 based on the responses that he receives. If the organizer decides to proceed with the call, then the relevance server stores the particulars 22 of the conference call, that is, participant information, time and date, originator's telephone number, and any other related data. It then sends a confirmatory email to all of the participants 24, and enters the call into the organizer's schedule in his PIM application 26.

If the organizer decides not to proceed at step 20, then an email cancellation will be sent to the participants at step 28. The organizer will then have the option of proposing a new conference call at step 30. If he decides not to proceed, then the application closes at step 32, otherwise, control returns to step 14 so that a new conference communication can be proposed.

This system provides for a much more efficient method offsetting up conference calls than known systems and methods.

As noted in the Background of the Invention above, prior art systems typically require more steps as the organizer must interact separately with the provider of the conference bridge. With the system of FIG. 1, the conference bridge is tightly tied to the system, so the organizer does not have to interact with it at all, much less having to interact with a third party.

As well, the organizer is able to leverage off of his existing PIM software in many ways, including: setting up the proposed conference call as easily as setting up any meeting or appointment, selecting participants from his contact list, investigating the availability of participants from their personal schedules, automatically having emails generated and automatically having the confirmed conference entered into his schedule. This makes for a very user-friendly system as users who are familiar with their PIM software have almost nothing more to learn.

FIG. 2 presents a flow chart of a complementary method of initiating and holding a conference communication. This method could be performed completely independently of the setup method, though it is preferred that both be performed as part of the same system.

Participants simply call the conference organizer's normal telephone number (or contact him via any other unique resource identifier) and they are automatically placed in the conference because they appear on the list of conference participants. The first participant to call the organizer, during the specified time of the conference, causes the conference bridge to be setup and all of the required participants to be contacted and joined into the conference bridge. The participants do not need to remember or record a bridge telephone number conference number, pin code or any other information that is particular to the conference communication. If a caller is not listed as a participant in the conference call they are routed elsewhere, for example, to voicemail, or to a delegate such as a receptionist or assistant to the originator of the conference. If the caller is very important to the organizer but is not a conference call participant, the caller could be rerouted to the organizer's communications device but not into the conference bridge FIG. 2 outlines this process in greater detail.

The process begins with the arrival of a call on the organizer's normal telephone number at step 42. This waiting step 42 is shown as a loop in this figure, but this is in the interest of simplicity only. Different telephone, PBX, IP-PBX and Internet Telephony systems will detect the arrival of incoming calls in different ways, using polling, interrupts, and the like.

When a call arrives at step 42, the organizer's relevance engine notes that a conference call is scheduled and determines whether the calling party is on the participant list for the conference, at step 44. Additional information on the development of the relevance engine appears in the co-pending U.S. patent application Ser. No. 11/382,130 titled “Method of and System for Telecommunication Management”, and incorporated herein by reference. In the case of step 42, the relevance engine's task is quite simple—monitoring the organizer's PIM so it knows that the organizer has set up a conference call, and considering whether calling parties should be allowed to join that conference call.

Of course, the conference communication organizer could also initiate the conference himself by calling his own telephone number. If the organizer calls his own telephone number from any of his devices (cellular telephone, desk telephone, or personal digital assistant, for example), the system will recognize that he should be in the conference and call all of the “required” participants The organizer may also initiate a conference from a personal computer or personal digital assistant that uses web services to communicate with the server supporting the system, and call all of the “required” participants including himself.

In the general case, the relevance engine considers how to handle communications based on the user's current “context”, and a set of tubes that the user has established. The relevance engine may be set up, for example, to determine the current physical location of a particular participant by monitoring usage of their desk top computer, cellular telephone or home telephone, and making an attempt to locate the participant at a corresponding telephony device. If the participant is using his desktop top computer to send emails, for example, the relevance engine will expect that the participant can be reached at his desk top telephone. The relevance engine may also have specific rules established which prevent unimportant telephone calls from going to the participant immediately prior to a conference call.

Some of the context parameters that the relevance engine might consider include the following:
Day and Time,
On/Off hook status of communication devices,
Current activity,
PC activity,
Communication history with watcher,
Physical Velocity of the user (driving, running, etc.),
Mood of the user,
Ambient noise and environment, and
Location of the user.

The task of determining whether the caller is on the participant list for the conference, at step 44, is done by determining the caller ID/SIP unique resource identifier, and checking to see whether this calling telephone number matches a participant's telephone number in the conference data file. Caller ID is well known functionality that is available on both the PSTN and most Internet-based telephony systems.

The conference data file will typically have more than one telephone number for each participant, including for example, their office, home and mobile telephone numbers. Thus, the participant may call from any one of these locations and a match will still be found so they can join the conference.

If the calling party is not on the participant list or is on the list but is calling from a telephone number that is not on the list, then control passes to step 50 where an interactive voice response (IVR) system challenges the caller for information that might allow them to access the conference bridge. For example, the PBX/Phone switch's IVR could answer the call and direct the calling party to enter the telephone number that they usually call from. This new telephone number could then be compared against the conference communication data file.

This could happen at the beginning of the call, or once the caller had been sent to voicemail. So if someone that is supposed to be in the conference call ends up in voicemail, the phone switch would ask the user to type in their usual phone number and then the switch would query conference call data file again and the caller would be connected to the conference communication bridge.

If it is determined that the calling party should not be allowed to join the conference communication at step 50, the calling party is rejected and sent to another endpoint at step 52, for example going to voicemail. The originator's relevance engine would be used here to determine the correct device that the call should be routed to, such as his user's device, voicemail, decline or a redirected to a delegate.

If it is determined that the calling party should be allowed into the conference communication at step 44, then the system determines whether the calling party that has just been accepted, is the first caller into the conference communication at step 47. If so, then the system will open a conference bridge, and generate a “call out” list to call all of the remaining required participants at step 48, along with the organizer, using the IVR to remind them of the scheduled conference call. The system will call these patties on their most appropriate communication device, so they are joined into the call as quickly as possible. This minimizes the time that the first participant will remain alone on the conference call, and also minimizes the delay while waiting for other participants to join.

It is then determined at step 53 whether the organizer has joined the conference call. If not, then the system will attempt to locate the organizer at step 54, on his most appropriate device. The identification of the organizer's “most appropriate communication device” can be done using the context engine as described in the co-pending U.S. patent application Ser. No. 11/382,130, incorporated herein by reference. As noted above, the context engine will seek out the best way to contact the organizer based on his current “context”, for example, monitoring the usage of his desk top computer, cellular telephone or home telephone, and making an attempt to locate the participant at a corresponding telephony device.

The caller is then connected to the conference bridge at step 55, and an announcement of the new participant's arrival is made at step 56.

The system then waits for additional calls to arrive at step 58. If a new call is received, then processing loops back to step 44 for processing. Otherwise, processing loops through query 60 where the termination of the conference communication is considered. If the conference is to continue, then control passes back to step 58 to check for more calls If the conference is to be terminated, then an announcement to that effect is made to step 62 and the conference bridge is dropped at step 64. Conference communications may terminate by timing out, or having all participants drop the conference.

As noted above, this initiation process for conference communications offers many advantages over the known systems, in particular, in reducing the number of steps, improving the reliability of reaching all of the participants, and increasing the likelihood that the participants will successfully be able to join the conference.

FIG. 3 presents an exemplary system diagram for operating the process described in FIGS. 1 and 2.

At the heart of the system is the relevance engine server 70. The relevance engine server 70 responds to queries with action to take and related arguments. For example, a conference call action is accompanied by a list of other phone numbers that the system should call and then join into the conference. This list will include the device that the organizer should be reached on that moment in time. As described above, the relevance engine server 70 is operable to:
examine the user's context stored in a database and determine that the user has scheduled a conference communication;
based on each caller's telephone number determine whether an incoming caller was invited to the conference communication;
specifying that a phone switch 76 should create a conference bridge in response to certain circumstances (for example, conference scheduled and the arriving of the first incoming participant);
if the caller is identified as a participant, the caller will be joined into the conference call;
if the caller is the first participant to call the user, the relevance engine determines who all the required participants are and which telephone numbers the should be contacted to expedite initiation of the conference communication; and
the relevance engine also determines which device the organizer should be called on and expedites his participation in the call.

The Personal information manager (PIM) server/client 72 can be any compatible, interactive PIM server such as Outlook Exchange/Microsoft Outlook for the PC. The relevance engine server 70 should be able to retrieve contact and calendar information from the PIM server.

The Personal information manager (PIM) client 74 is a client plug-in that is integrated with the personal management software running on the organizer's personal computer (PC). It can communicate with the relevance engine server 70 via the network/Internet and pushes up contact and calendar information to the relevance engine server 70. It also allows the organizer to specify that an appointment is a conference call.

The system also includes a standard telephone switch 76 of some sort, such as a PBX, IP PBX or other system that is capable of supporting conference calls. The telephone switch 76 must also have the functionality to query the relevance engine server 70 every time an incoming call is received, to receive instructions on how to route the call. Any number of remote communication devices 78 may also be a part of the system, including desk top telephones, cellular telephones, personal digital assistants (PDAs), Internet-ready telephones, VOIP (voice over Internet protocol) telephones, television set-top boxes, and the like.

In the context of communications between the devices in this exemplary system diagram, the method would proceed as follows. Firstly, the call organizer creates an appointment in his PIM client 74, which is sent to the relevance engine server 70 via communication A. The PIM client 74 also sends appointment invitations to all of the prospective participants 78 via communication B.

When the first participant calls the organizer's telephone number at C, the telephone switch 76 receives the call and queries the relevance engine server 70 at D for instructions. The relevance engine server 70 is in communication with the PIM server 72 and possibly other field devices, to keep the organizer's context current so that proper communication control decisions can be made. The relevance engine server 70 determines whether the caller is a conference participant, and if so, replies to telephone switch 76 at E, to initiate the conference call and to expedite the other participants on the list. The telephone switch 76 then calls the balance of the participants 78 (in this case, paticipant2 and participant3) at F and F′.

If a caller dials the organizer's telephone number during the call, at G, then the telephone switch 76 will receive the call and query the relevance engine server 70 at H for instructions on how to route the call. The relevance engine server 70 determines whether the caller should be in the conference, and instructs the telephone switch 76 at I, whether to connect the call to the conference bridge or send it to voicemail (for example). The telephone switch 76 then routes this incoming call accordingly.

As noted above, this design allows for every telephone number on the local system to have an attached conference bridge that is dynamically created when a participant calls the user during the duration of the conference call. It significantly simplifies and reduces the time required to setup and initiate a conference call.

This system reduces the time to initiate a conference call from 5-10 minutes down to less than a minute. Therefore, the overall solution reduces the time required to setup and initiate a conference call from 15-25 minutes down to about 2 minutes. This system also provides many other advantages.

Conference call participants do not have to store a separate phone number for a conference call—they simply call the organizer's normal phone number. They do not have to enter a pin code because the relevance engine can distinguish conference call participants from other callers. The organizer is automatically joined into the conference when the first participant calls their phone number, avoiding the problem of a participant waiting in an empty conference bridge waiting for the organizer to join.

The system is compatible with existing telecommunications devices and infrastructure, making it quick and easy to roll out, as well as very cost-effective.

Other advantages would be clear to the person skilled in the art from the description herein including the following options and alternatives discussed hereinbelow.

While particular embodiments of the present invention have been shown and described, it is clear that changes and modifications may be made to such embodiments without departing from the true scope and spirit of the invention. For example:
participants could be asked to provide the telephone number that they expect to be calling from, when they respond to the invitation to join the conference call. In this way, they could call from virtually any telephone number regardless of whether it is already in the organizer's address book;
the conference invitations could identify the phone number that the particular participant will be prompted at, giving them the opportunity to identify a different number;
the conference invitations could identify all of the telephone numbers associated with each particular participant, so that they could make corrections and/or additions if necessary;
the conference bridge could be permanently attached to the user's phone number guaranteeing enough conference bridges in the system;
the conference bridge could use voice recognition to identify a conference participant instead having them type in the phone number they usually use; and
the user could initiate the conference call directly from their PIM application When a link or button is clicked the server notifies the conference bridge to call all the required attendees as well as the conference organizer.

The present invention has been described with regard to one or more embodiments. However, it will be apparent to persons skilled in the art that a number of variations and modifications can be made without departing from the scope of the invention as defined in the claims.

The method steps of the invention may be embodiment in sets of executable machine code stored in a variety of formats such as object code or source code. Such code is described generically herein as programming code, of a computer program for simplification. Clearly, the executable machine code may be integrated with the code of other programs, implemented as subroutines, by external program calls, in firmware or by other techniques as known in the art.

The embodiments of the invention may be executed by a computer processor or similar device programmed in the manner of method steps, or may be executed by an electronic system which is provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

The invention could, for example, be applied to computers, smart terminals, personal digital assistants, Internet-ready telephones, Internet-connected information kiosks, automobile telematics systems and television set-top boxes (STBs). Again, such implementations would be clear to one skilled in the art, and do not take away from the invention.

All citations are hereby incorporated by reference.

What is claimed is:

1. A method of conference communication management comprising the steps of:
scheduling a conference communication with a number of participants, using a unique resource identifier of an originator of the conference communication as the dial in number;
responding to arrival of a call on said unique resource identifier of the originator of the conference communication by:
determining whether said calling party should be allowed to join said conference communication; and
responding to said calling party being allowed to join said conference communication by connecting said calling party to said conference communication bridge;
otherwise, routing the call on said unique resource identifier of the originator, elsewhere.

2. The method of claim 1 further comprising the prior step of generating a list of participants for said conference communication, and wherein said step of determining whether said calling party should be allowed to join said conference communication comprises the step of determining whether said calling party is on said list of participants.

3. The method of claim 2 wherein said step of determining whether said calling party should be allowed to join said conference communication comprises the step of comparing said calling party's telephone caller ID to a list of participant telephone numbers stored in a conference data file.

4. The method of claim 2 wherein each participant in said list of participants is identified as either optional or required.

5. The method of claim 2 further comprising the steps of:
responding to arrival of a call from a party not appearing on said list of participants for said conference communication by challenging said calling party not on said list of participants to provide additional information regarding their entitlement to access said conference communication;
receiving and considering said additional information; and
in response to said additional information being acceptable, connecting said calling party not on said list of participants to said conference communication bridge.

6. The method of claim 2 further comprising the step of responding to said calling party not appear on said list of participants for said conference communication by connecting said calling party to a service selected from the group consisting of one of said originator's devices that is not on said conference bridge, a voicemail service, a delegate telephone number, an interactive voice response (IVR) system, a switchboard, a receptionist and an assistant to said organizer.

7. The method of claim 1 further comprising the step of:
responding to an accepted calling party being the first accepted calling party on said conference communication by opening said conference bridge.

8. The method of claim 7 further comprising the steps of:
responding to an accepted calling party being the first accepted calling party on said conference communication by:
expediting all of the remaining required participants to join said conference communication; and
expediting the originator of said conference call, to join said conference communication.

9. The method of claim 8 wherein said steps of expediting comprise the step of dialing telephone numbers of said participants and said originator.

10. The method of claim 8 wherein said steps of expediting comprise the prior step of identifying a communication device on which each participant is most likely to be found.

11. The method of claim 10 wherein each participant's communications devices includes at least one selected from the group consisting of a cellular telephone, a public switch telephone network phone, a personal digital assistant, a personal computer, an Internet-ready telephone, a voice over IP telephone and a television set-top box.

12. The method of claim 10 wherein said step of identifying comprises the step of considering each participant's contextual criteria, including at least one criterion selected from the group consisting of day and time, on/off hook status of communication devices, current activity, PC activity, communication history with watcher, physical velocity of the user such as driving or running, mood of the user; ambient noise and environment and location of user.

13. The method of claim 2 wherein further comprising the steps of:
said originator using a personal information manager (PIM) to propose a conference communication by creating a special case of a new appointment defined as a conference communication; and
sending an email notification of said proposed conference communication to a list of participants.

14. The method of claim 13 further comprising the step of 'said organizer populating said list of participants using a list of contacts or addresses in said PIM.

15. A conference communication management system comprising:
an originator communication device;
two or more participant communication devices;
a telephone switch including a conference bridge;
a relevance server;
a communication network interconnecting said originator communication device, said two or more participant communication devices, said telephone switch and said relevance server;
said relevance server being operable to:
respond to arrival of a call on said telephone number of said originator communication device, during a scheduled conference communication, by:
determining whether said calling patty should be allowed to join said conference communication; and
responding to said calling party being allowed to join said conference communication by connecting said calling party to said conference communication bridge;
otherwise, routing the call on said telephone number of the originator, elsewhere.

16. The system of claim 15 wherein said scheduled conference communication is further defined by a list of participants, and wherein said relevance server is operable to determine whether said calling party should be allowed to join said conference communication by determining whether said calling patty is on said list of participants.

17. The system of claims 16 further comprising a personal information manager (PIM) operable to:
generate a proposed conference communication defined as special case of a new appointment; and
send an email notification of said proposed conference communication to said list of participants.

18. The system of claim 17 wherein said relevance server is further operable to respond to an accepted calling party being the first accepted calling party on said conference communication by directing said telephone switch to open a conference bridge.
